(19) United States
(12) Patent Application Publication
(10) Pub. No.: US 2011/0126680 A1
(43) Pub. Date: Jun. 2, 2011

(54) Apparatus for slicing food products

(75) Inventor: Guenther Weber, Gross Nemerow (DE)

(73) Assignee: Weber Maschinenbau GmbH Breidenbach, Breidenbach (DE)

(21) Appl. No.: 12/957,214

(22) Filed: Nov. 30, 2010

(30) Foreign Application Priority Data
Dec. 2, 2009 (DE) 10 2009 056 670.8
Feb. 16, 2010 (DE) 10 2010 008 047.0

(51) Int. Cl. B26D 1/157; B26D 5/02; B26D 7/06

(52) U.S. Cl. 83/13; 83/471.2; 83/477

(57) ABSTRACT

The invention relates to an apparatus for slicing food products, in particular to a high-performance slicer, comprising a product feed, at least one cutting blade which rotates about a blade axis and/or orbits a center axis in a planetary manner and to which at least one product to be sliced can be fed in a product feed direction and having an adjustment device for the cutting blade with which the cutting blade is movable in an adjustment direction, with the blade axis and/or the center axis of the cutting blade being inclined with respect to the horizontal during the slicing and with the adjustment direction of the cutting blade extending obliquely to the blade axis and/or to the center axis of the cutting blade.

The invention relates to an apparatus for slicing food products, in particular a high-performance slicer, having a product feed, at least one cutting blade which rotates about a blade axis and/or orbits a center axis in a planetary manner and to which at least one product to be sliced can be fed in a product feed direction and having an adjustment device for the cutting blade with which the cutting blade is movable in an adjustment direction, with the blade axis and/or the center axis of the cutting blade being inclined with respect to the horizontal during the slicing.

Such apparatus are generally known and serve to cut food products such as sausage, meat and cheese into slices at high speed. Typical cutting speeds lie between several 100 to some 1,000 cuts per minute. Modern high-performance slicers differ inter alia in the design of the cutting blade as well as in the manner of the rotary drive for the cutting blade. So-called scythe-like blades or spiral blades rotate about an axis of rotation also called a blade axis here, with this axis of rotation itself not carrying out any additional movement. Provision is, in contrast, made with circular blades to allow the rotating circular blade additionally to orbit in a planetary manner a further axis (here also called a center axis) spaced apart from the axis of rotation. Which blade type or which kind of drive is to be preferred depends on the respective application. It can generally be stated that higher cutting speeds can be achieved with only rotating scythe-like blades, whereas rotating circular blades additionally orbiting in a planetary manner can be used more universally without compromises in the cutting quality.

The above-mentioned high cutting speeds make it necessary—and this applies independently of the type of blade and of the kind of drive—that, with a portion-wise slicing of products, so-called blank cuts are carried out in which the blade continues to move, i.e. carries out its cutting movement, but does not cut into the product in so doing, but rather cuts “into space” so that temporarily no slices are cut from the product and these “cutting breaks” can be used to transport away a portion formed with the previously cut-off slices, for example a slice stack or slices arranged overlapping. The time elapsing between two slices cut off after one another is not sufficient for a proper transporting away of the slice portions from a specific cutting performance or cutting speed onward. The length of these “cutting breaks” and the number of blank cuts per “cutting break” depend on the respective application.

A problem known in practice in connection with the carrying out of blank cuts is that it is not sufficient in most cases simply to stop the feed of the product temporarily to prevent the cutting off of slices. With products having a soft consistency, it namely regularly occurs that after the stopping of the product feed, relaxation effects come into force, whereby the front product end moves beyond the cutting plane and thus enters into the active zone of the cutting blade. The consequence is an unwanted cutting off of so-called product snippets or product scraps. Apart from this, such a scrap formation always necessarily occurs independently of the product consistency whenever the products are continuously supplied during the slicing operation, i.e. even with products of a solid consistency in which therefore the above-mentioned relaxation effects do not occur, there is scrap formation with a continuous product feed.

The above-described phenomena are sufficiently known to the skilled person so that they will not be looked at in more detail.

Measures are already known from the prior art, for example, which serve to avoid scrap formation on the carrying out of blank cuts. Reference is made for this purpose, for example, to EP 0 289 765 A1, DE 42 14 264 A1, EP 1 046 476 A2, DE 101 147 348 A1, DE 154 952, DE 10 2006 043 697 A1 and DE 103 33 661 A1.

It has accordingly already been proposed not only to interrupt the product feed for carrying out blank cuts, but additionally to retract the product—if necessary together with the product support. This approach in particular reaches its limits when the cutting speeds and/or the masses to be moved in this process become too large since it can then no longer be ensured that the front product end can be retracted sufficiently fast. As an alternative to the retraction of the product, it has furthermore already been proposed to move the cutting blade away from the front product end. Both solution approaches have the consequence that a sufficiently large spacing is established between the front product end and the cutting blade which reliably prevents scrap formation. The required blade stroke only amounts to a few millimeters; however, it must take place in a very short time in the order of a few hundredths of seconds. The possibility of a blade adjustment can also be utilized for further additional functions, e.g. for setting the cutting gap or for blank cuts within the framework of a vertical adjustment or an adjustment of the dipping depth of the cutting blade which in particular takes place with respect to the product or products to be sliced or with respect to the product support, which will be looked at in more detail in the following.

The prior art proposes various possibilities of establishing the desired spacing between the blade and the product by a transposition of the blade.

One possibility, which is described, for example, in DE 101 47 348 A1, comprises only moving the rotating blade holder to which the blade is replaceably attached and which is also called a blade mount, blade shaft or rotor, and indeed relative to the other components of the so-called blade head which in particular includes, in addition to the mentioned blade holder, a rotary bearing for the rotational movement of the blade or of the blade holder as well as a base part with which the blade head and thus the blade holder is fastened to a rack or frame of the slicer. This fastening can take place, for example, at or in a so-called cutting head housing to which or in which not only the blade head together with the blade is attached, but also the drive motor for the rotary blade drive cooperating with the blade head e.g. via a drive belt.

It is also possible to displace the blade head as a whole so that a relative movement between the blade holder and the rotary bearing of the blade is not required to adjust the blade. Such a solution is found, for example, in DE 10 2006 043 697 A1.

It is furthermore possible to move the whole cutting head housing together with the blade head and the rotary drive. Solutions of this kind are described, for example, in EP 1 046 476 A2.

These solution approaches explained above do not only differ with respect to the size of the mass to be moved, but also with respect to the construction effort as well as with respect to the applicability for different blade kinds or drive kinds. A movement of only the blade, for example, admittedly has the advantage of a relatively small mass to be moved, but means a substantial construction effort since an object has to be displaced with the blade along an axis and simultaneously rotates at high speed about just this axis. Problems in connection with the journalling of the blade or of the blade holder have to be solved for this purpose. Whereas the above-mentioned scythe-like blades or spiral blades only rotate about one axis, but this axis does not additionally carry out an orbiting movement, concepts for the adjustment of the blade can be realized with a justifiable effort despite the mentioned journalling problems. This is different with slicers having rotating circular blades which simultaneously orbit in a planetary manner since there is the problem here of effecting a transposition of only the blade or of the blade holder with a justifiable construction effort.

All known solutions which effect a transposition of the blade either by movement of the blade holder, of the blade head or of the cutting head housing, however, have one thing in common, namely the necessity of moving the respective assembly against the effect of the earth's gravitational pull when—e.g. in conjunction with the carrying out of blank cuts—the blade has to be moved from a disengaged position back into the cutting position. This is due to the fact that with the slicers of the kind in question here the slicing always takes place in practice with a blade axis or a center axis inclined with respect to the horizontal, with the product feed likewise being inclined with respect to the horizontal, and indeed also when—as generally known e.g. for cutting oval slices from products with a circular cross-section—the cutting plane defined by the edge of the blade does not extend perpendicular to the product feed. During the slicing, the product to be sliced consequently lies on a “slanted plane” which is typically inclined approximately 40° with respect to the horizontal when the slicing takes place with a product feed extending perpendicular to the cutting plane.

On the adjustment movement of the blade away from the front product end taking place parallel to its axis of rotation inclined with respect to the horizontal, the earth's gravitational pull admittedly has an assisting effect. However, on the return movement of the blade into the cutting position, the adjustment device must additionally work against a portion of the weight of the assembly to be moved in each case dependent on the angle of inclination. This raising obviously has a more disadvantageous effect, the heavier the unit to be moved is. Even on the adjustment of only the blade holder, including the blade, however, the mentioned portion of the weight is relevant such that it has to be taken into account in the design, construction and arrangement of the adjustment device.

It is the object of the invention to further improve a slicing apparatus having an adjustable cutting blade, in particular against the background of the problems described above.

This object is satisfied by the features of claim 1.

In accordance with the invention, the adjustment direction of the cutting blade extends obliquely to the blade axis and/or to the center axis of the cutting blade.

The invention thus means a turning away from the established idea of the professional world documented by the prior art that the adjustment movement of the cutting blade has to take place parallel to the axis of rotation of the cutting blade; that is, in the terminology used here, parallel to the blade axis and/or center axis. The portion of the weight to be overcome can be lowered or—as in a preferred embodiment with a horizontally extending adjustment direction—reduced to zero by the approach in accordance with the invention of moving the cutting blade obliquely to its axis of rotation. The invention thus allows a weight-neutral blade adjustment in which only the inert mass of the assembly to be moved plays a role in the case of a horizontal adjustment movement from the view of the adjustment device.

However, the invention thus not only achieves the advantage of a lower performance demand on the adjustment device, but rather further advantages are moreover achieved:

If, in accordance with the prior art, the blade is adjusted parallel to its axis of rotation, the adjustment path is then identical to the change in spacing caused by the adjustment between the blade and the front product end or between the blade and the cutting edge since the axis of rotation of the blade and the product feed direction extend parallel to one another. If, in contrast, in accordance with the invention, the adjustment direction extends obliquely to the axis of rotation of the blade, the blade has to cover a larger path in comparison with the prior art to effect the same change in spacing. This increase in the adjustment path is actually an advantage since—as already initially explained—the adjustment paths in question here are anyway small, namely only a few millimeters up to a maximum of a few centimeters, which is generally problematic with respect to the design and operation of the adjustment device. The precision of adjustment movements is namely the more difficult to ensure, the shorter the adjustment path is. Particularly the blade movements required with high-performance slicers require a very high degree of precision so that correspondingly high demands are made on the drive technology, particularly since only extremely brief times are available for the adjustment movements, as likewise explained in the introductory part. As long as the required adjustment path does not become too large overall, any increase in the adjustment path which results—from the viewpoint of the adjustment device—thus represents a facilitation to the extent that the required precision of the adjustment movement can be realized more simply or becomes possible at all.

To illustrate these relationships, it can be mentioned by way of example that in the case of a spindle drive for the blade movement, such as is known from DE 101 47 348 A1, the spindle only makes approximately half a revolution for the adjustment movement taking place parallel to the axis of rotation of the blade, which already represents an optimization with respect to the drive technology used. It has been shown in practice that problems hereby result in connection with the lubrication of the spindle, which would not be the case if the spindle could carry out at least one full revolution, e.g. in an oil bath.

It also becomes clear in view of this state of affairs that an enlargement of the adjustment path can provide unexpected additional advantages in that, for example on use of a spindle drive for the adjustment device, the required spindle lubrication is simplified.

It can furthermore generally be said that the invention allows a higher regulation quality for the drives since more uniform load relationships and larger adjustment paths are present.

Advantageous embodiments of the invention are also set forth in the dependent claims, in the description and in the drawings.

As already mentioned above, provision can be made in accordance with a possible embodiment of the invention that the adjustment direction of the cutting blade extends at least approximately horizontally. The “weight portion” of the blade on the adjustment is in this way reduced to zero, i.e. the adjustment device no longer has to “raise” the blade.

The adjustment device for the cutting blade can include a linear drive, for example a spindle drive or a piston-in-cylinder arrangement. The axis of rotation of the spindle drive or the longitudinal axis of the piston-in-cylinder arrangement preferably extends parallel to the adjustment direction of the cutting blade. Alternatively, the adjustment device for the cutting blade can include an eccentric drive.

In a possible embodiment, a blade head is movable as a whole in the adjustment direction to adjust the blade. The blade head in particular includes a blade holder to which the cutting blade is replaceably attached and at least one rotary bearing for the movement of the cutting blade about the blade axis and/or about the center axis. Due to the movement of the blade head as a whole, no relative movement takes place in the adjustment direction between the blade holder and the rotary bearing. This represents a simplification in a construction regard.

A particular advantage of a movement of the blade head as a whole is that the blade head is both a scythe-like blade head for a scythe-like blade rotating about the blade axis and a circular blade head for a circular blade rotating about the blade axis and orbiting the center axis in a planetary manner. Irrespective of how the adjustment device is specifically designed, this therefore means that the respective adjustment principle can be used both for a scythe-like blade and for a circular blade.

A carrier which is stationary with respect to the adjustment direction, which is, for example, a component of a fixed-position rack of the slicing apparatus or which is fastenable to the rack can be provided and the blade head is movable relative thereto as a whole in the adjustment direction. This carrier can be made universal such that a change can be made between a scythe-like blade head and a circular blade head. A scythe-like blade slicer can thus be converted in a particularly simple manner into a circular blade slicer and vice versa.

Provision is furthermore in particular made that the cutting blade is movable in the adjustment direction for carrying out at least one additional function, in particular for carrying out blank cuts which are e.g. carried out in a portion-wise slicing and/or within the framework of a vertical or immersion depth setting and/or for the cutting gap adjustment.

The term “additional function” is to be understood such that a function is meant by it which does not relate exclusively to the actual slicing function, that is the rotational movement or orbital movement of the cutting blade. The additional function is in particular the carrying out of blank cuts or the setting of the cutting gap, which will be looked at in more detail in the following. The additional function can also be a vertical setting or a setting of the dipping depth of the cutting blade, in particular with respect to the product or products to be sliced or with respect to the product support, more precisely the avoidance of scrap formation with blank cuts carried out within the framework of the vertical or dipping depth setting. The adjustment movement of the blade therefore takes place as required whenever the additional function should be carried out, with this additional function being able to be carried out—depending on its kind—with a rotating or orbiting cutting blade and/or with a stationary cutting blade.

Provision can furthermore be made in accordance with the invention that the cutting blade is movable in the adjustment direction such that the spacing between the cutting blade and a reference plane which extends parallel to a cutting plane defined by the cutting edge of the cutting blade is changed.

It must be mentioned in this connection that for most of the situations relevant to practice in which an adjustment of the cutting blade is necessary or desired a maximum adjustment path of no more than 5 to 10 mm is sufficient, with in many cases the maximum required adjustment paths even being smaller than 5 mm. It is in particular sufficient for carrying out scrap-free blank cuts if a spacing of a few millimeters is established between the cutting blade and the front product end. This also applies to the cutting gap setting since in most cases a maximum gap size of a few millimeters does not need to be exceeded or may not be exceeded at all.

On the cutting gap adjustment, the gap between the cutting blade—more precisely the cutting plane defined by the edge of the blade—and a cutting edge is set to a preset dimension. The cutting edge also called a counter-blade cooperates with the cutting blade on the cutting of slices from the product. The cutting edge in particular forms the end of the product support disposed at the front in the direction of the product feed. Cutting edges occur in a variety of embodiments in practice. Even relatively complex arrangements which are provided, for example as so-called cuffs or molded shells, with leadthroughs which are open or closed in the peripheral direction for the products to be sliced in order ideally to fix the front product end to increase cutting quality are frequently simply called a “cutting edge” in practice.

Depending on the product to be sliced and optionally on other circumstances, it is necessary for an ideal cutting quality to set the spacing—in the product feed direction, that is measured perpendicular to the cutting plane—to a specific dimension between the cutting blade and the cutting edge. The axial position of the cutting plane is not exactly defined to this extent since the plane defined by the cutting edge, on the one hand, and the plane defined by the cutting blade—more precisely: by the blade edge—on the other hand, likewise do not coincide. This is, however, unproblematic in that, for example, the plane defined by the cutting edge can be used as a reference plane when a reference in the axial direction, that is in the product feed direction, is needed or desired.

A further advantage of the invention, which is also of importance in this connection, comprises the fact that it is possible that the cutting blade maintains its orientation relative to the product feed direction, in particular that the cutting plane therefore extends perpendicular to the product feed direction in every blade position. The movability of the cutting blade can thus also be utilized for such functions—such as the above-explained cutting gap setting—in which a non-parallel alignment of the cutting blade relative to the original cutting plane, that is, for example, a tilting of the cutting blade during the adjustment movement, cannot be accepted. Whereas the orientation which the cutting blade adopts with respect to the product feed direction is generally unimportant for carrying out blank cuts as long as a sufficiently large spacing is present between the cutting blade and the front product end, it is obviously absolutely necessary for an adjustment of the cutting blade for the purpose of the cutting gap setting that the cutting blade is aligned with the cutting plane perpendicular to the product feed direction in every position since the cutting blade has to satisfy the actual cutting function in every position.

In accordance with a further aspect of the invention, it is furthermore proposed that the cutting blade is pivotably journalled and is pivotable for carrying out at least one additional function, in particular for carrying out blank cuts, for the cutting gap setting and/or the vertical or dipping depth setting such that the spacing between the cutting blade and a reference plane which extends parallel to the cutting plane or coincides with the cutting plane is changed and in this respect the cutting blade remains aligned parallel to the cutting blade or departs from a parallel alignment.

This aspect is disclosed and claimed both in combination with the subject matters disclosed in the claims and as an independent aspect.

The cutting blade can therefore accordingly be pivotable such that an adjustment direction, i.e. on adjustment to the start and the end of the adjustment movement, is effectively produced which extends obliquely to the blade axis and/or to the center axis of the cutting blade The adjustment movement of the cutting blade does not have to be a linear movement, with the pivotable journalling of the cutting blade, however, also being able to be made such that a linear adjustment movement of the cutting blade is produced.

As already mentioned, the term “additional function” is to be understood such that a function is meant by it which does not relate only to the actual slicing function, that is to the rotational movement or orbiting movement of the cutting blade. The additional function is in particular the carrying out of blank cuts or the setting of the cutting gap, which will be looked at in more detail in the following. The additional function can also be a vertical setting or a setting of the dipping depth of the cutting blade, in particular with respect to the product or products to be sliced or with respect to the product support. The pivoting of the cutting blade therefore takes place when the additional function should be carried out, with this additional function being able to be carried out—depending on its type—with a rotating or orbiting cutting blade and/or with a stationary cutting blade.

The pivotable bearing has the advantage that the forces required for the pivoting can be kept relatively small. Furthermore, the pivoted journalling has the advantage that no plain bearings or slide bearings are needed such as are required with a purely translatory, for example axial, adjustment movement.

The embodiment of the pivotable bearing possible in accordance with this aspect such that the cutting blade remains aligned parallel to the cutting plane has inter alia the advantage that the movability of the cutting blade can also be utilized for such functions in which a non-parallel alignment of the cutting blade relative to the cutting plane, that is, for example, a tilting of the cutting blade during the adjustment movement, cannot be accepted. Whereas it is irrelevant to the carrying out of blank cuts which orientation the cutting blade adopts with respect to the cutting plane as long as a sufficiently large spacing is present between the cutting blade and the front product end, it is obviously absolutely necessary on an adjustment of the cutting blade for the purpose of setting the cutting gap that the cutting blade is aligned parallel to the cutting plane in every position since the cutting blade has to satisfy the actual cutting function in every position.

The embodiment of the pivotable bearing possible in accordance with this aspect such that the cutting blade departs from a parallel alignment can in particular be used when a non-parallel alignment of the cutting blade relative to the cutting plane is not only non-critical, but is moreover associated with an advantage, because e.g. a desired large spacing between the cutting blade and the front product end can be established particularly fast and/or simply, as is in particular sensible for carrying out blank cuts.

Provision can be made that the pivot movement of the cutting blade takes place about at least two axes and/or is a superimposition of at least two pivot movements.

Provision is made in an embodiment of the invention that a cutting head is provided which includes the cutting blade and is pivotable as a whole. This further development of the invention has inter alia the advantage that a bearing required for a rotation of the cutting blade is not affected by the adjustment movement. It is thus not necessary for the practical implementation of the invention to develop special cutting heads since the invention can be used in conjunction with conventional cutting heads which do not allow an adjustment movement of the blade or of the blade shaft without an adjustment movement of the cutting head as a whole.

A further advantage of this embodiment of the invention is that it is independent of the type of blade and of the manner of the drive of the blade. Both a scythe-like blade cutting head in which the cutting blade only rotates and a circular blade cutting head in which the circular blade rotates and additionally orbits in a planetary manner can be pivoted as a whole in the manner in accordance with the invention.

The term “cutting head” is to be understood widely in that the size or the extent of the unit pivotable as a whole is not fixed hereby. Depending on the specific embodiment of the slicing apparatus, a drive motor providing the rotary drive of the cutting blade can in particular either belong to the cutting head and can thus be pivoted in common with the cutting blade and the other components or cannot take part in this pivoting. The drive means between a drive motor which is stationary in this respect, on the one hand, and a cutting blade or blade shaft, on the other hand, can in this case be designed so that they permit the pivot movement. Furthermore, the cutting head can only include a so-called blade head which can in particular include the cutting blade together with the holder and the transmission or the blade head and a so-called blade head housing which at least partly surrounds the blade head and can include the drive motor providing the rotary drive of the cutting blade, with the latter, however, not being absolutely necessary.

It must be taken into account in this connection that a maximum adjustment path of no more than 5 to 10 mm is sufficient for the situations relevant in practice in which an adjustment of the cutting blade is required or desired, with in many cases the maximum required adjustment path even being less than 5 mm. It is in particular sufficient for carrying out scrap-free blank cuts if a spacing of a few millimeters is established between the cutting blade and the front product end. This also applies to the cutting gap setting since in most cases a maximum gap size of a few millimeters does not need to be exceeded or may not be exceeded at all.

Other components than the mentioned drive motor, which are in the widest sense related to the drive, holder and/or journalling of the cutting blade, cannot belong to the cutting head to the extent that they do not participate in the pivot movement taking place for carrying out the at least one additional function. Furthermore, further components in addition to the drive motor, which are in the widest sense related to the drive, holder and/or journalling of the cutting blade, can participate in the pivot movement.

In practice, the unit to be pivoted overall as a whole can have a weight, for example, of 50 to 100 kg. Setting this mass briefly into motion, however, does not represent a problem due to the pivotable journalling in accordance with the invention which could not be solved with a justifiable construction effort since, with a corresponding relative arrangement of the pivot journalling and the pivot drive, in particular while utilizing long lever arms, the forces to be applied can be kept relatively small without having to design the pivot drive itself in an unnecessarily complicated manner.

When in the following a pivoting of the cutting blade is spoken of, then—if not otherwise mentioned—this should also be understood as the possibility of a pivoting of a cutting head as a whole including the cutting blade.

In accordance with a further embodiment of the invention, a parallelogram guide, at least one parallelogram guiding part and/or at least one four-bar lever are provided for pivoting the cutting blade which are each preferably pivotally connected to the cutting blade or to a cutting head or to its mount or holder, on the one hand, and to a base, on the other hand.

A pivoting of the cutting blade with an unchanged alignment of the cutting blade with respect to the cutting plane can hereby be realized in a relatively simple manner from a construction aspect.

In a further embodiment of the invention, at least one pair of guiding parts and/or levers can be provided for pivoting the cutting blade which are each pivotally connected to the cutting blade or to a cutting head, on the one hand, and to a base, on the other hand.

Base is here to be understood as a component of the slicing apparatus relative to which the pivot movement of the cutting blade takes place, with it admittedly not being compulsory in most practical cases, but nevertheless being provided that the base is stationary with respect to the environment, that is it does not itself carry out a movement of any kind relative to the environment.

The parallelogram guide, the parallelogram guiding part or the four-bar lever can be made such that their decisive elements, in particular guiding parts and/or levers, each have the same length. Alternatively or additionally, the pivotal connection points of the elements or guiding parts and/or levers can be selected so that the respective desired movement of the cutting blade is produced. Furthermore, the lengths and/or the pivotal connection points of the guiding parts and/or levers can be made changeable in order to be able to realize different movements of the cutting blade on the pivoting—depending on the selected setting or on the set configuration.

In accordance with a further possible embodiment of the invention, the cutting blade is suspended in a pivotable manner. The suspension can in particular take place at a base belonging to the slicing apparatus, with the base itself being able to be stationary with respect to the environment.

A further embodiment of the invention provides that a pivot drive is provided for the cutting blade. Provision can in particular be made that this pivot drive, which serves to pivot the cutting blade for carrying out the at least one additional function, is provided in addition to a rotary drive of the cutting blade which provides the movement of the cutting blade in the cutting plane, that is which is responsible for the rotation and/or orbiting of the cutting blade. A respective separate drive is then provided for the actual cutting, on the one hand, and the pivoting of the cutting blade, on the other hand. It is, however, also possible in accordance with the invention to derive the pivot operation by suitable means from a rotary drive of the cutting blade. These means are then in particular designed such that the cutting blade rotates without interruption, but that the pivoting of the cutting blade is only carried out on demand, that is when a pivoting of the cutting blade is necessary for carrying out the at least one additional function.

The pivot drive for pivoting the cutting blade can be made to act on the cutting blade along a line of action extending at least substantially perpendicular to the cutting plane. It is hereby possible to design the pivot drive particularly simply from a construction aspect. A simple piston-in-cylinder arrangement can serve as a pivot drive, for example. When the pivoting of the cutting blade is associated with a stroke, that is with a component of movement of the cutting blade in the cutting plane, the coupling between the pivot drive and the cutting blade can be made such that such a relative movement taking place in the cutting plane between the pivot drive and the cutting blade is permitted without impairing the pivoting of the cutting blade by means of the pivot drive.

It is also possible to journal the pivot drive movably. A relative movement between the pivot drive and the cutting blade, in particular in the sense of a clearance between the pivot drive and the cutting blade, can be avoided in this manner.

The invention also relates to a use of an apparatus of the described kind for carrying out blank cuts, in particular on the portion-wise slicing of food products and/or in a vertical or dipping depth setting., wherein for the temporary interruption of the cutting of slices from the product, the cutting blade is pivoted away from the front product end and is pivoted back again for the restart of the cutting of slices from the product after the carrying out of one or more blank cuts. In this respect, the apparatus is therefore not only used for slicing the products, but also during the slicing of a product, as required, for carrying out one or more blank cuts in order in this manner in particular to allow a portion-wise slicing with an ordered transporting away of the respective formed portions. The interruption of the cutting of slices from the product can naturally take place a plurality of times during the slicing of a product since, with the portion-wise slicing of the product, the number of “blank cut phases” corresponds to the number of the slice portions formed from the product.

In accordance with an embodiment of this use, the blank cuts are carried out with a stopped production advance.

The invention furthermore relates to the use of an apparatus of the described kind for setting the cutting gap, wherein the gap between the cutting blade and a cutting edge is set to a preset dimension by pivoting of the cutting blade. The cutting edge, also called a counter-blade, cooperates with the cutting blade on the cutting of slices from the product. The cutting edge in particular forms the end of the product support disposed at the front in the direction of the product feed. Cutting edges occur in a variety of embodiments in practice. Even relatively complex arrangements which are provided, for example as so-called cuffs or molded shells, with leadthroughs which are open or closed in the peripheral direction for the products to be sliced in order ideally to fix the front product end to increase cutting quality are frequently simply called a “cutting edge” in practice.

Depending on the product to be sliced and optionally on other circumstances, it is necessary for an ideal cutting quality to set the spacing—in the product feed direction, that is measured perpendicular to the cutting plane—between the cutting blade and the cutting edge to a specific dimension. The axial position of the cutting plane is not exactly defined to this extent since the plane defined by the cutting edge, on the one hand, and the plane defined by the cutting blade—more precisely: by the blade edge—on the other hand, likewise do not coincide. This is, however, unproblematic in that, for example, the plane defined by the cutting edge can be used as a reference plane when a reference in the axial direction, that is in the product feed direction, is needed or desired.

In a possible embodiment of this use, the cutting gap setting can be carried out with a stationary cutting blade. Alternatively, it is, however, also possible to carry out the cutting gap setting with a cutting blade moving in the cutting plane, which is also called a “dynamic cutting gap setting” and which offers advantages with respect to a “static” cutting gap setting with a stationary blade which will likewise not be looked at in more detail here.

The invention furthermore relates to a method for slicing food products, in particular by means of the described apparatus, in which at least one product is supplied by means of a product feed to a cutting plane in which at least one cutting blade moves, in particular in a rotating and/or orbiting manner, to cut slices from the product and the cutting blade is pivoted for carrying out at least one additional function, in particular for carrying out blank cuts, for setting the cutting gap and/or for the vertical and/or dipping depth setting such that the spacing between the cutting blade and a reference plane which extends parallel to the cutting plane or coincides with the cutting plane is changed and in this process the cutting blade remains parallel to the cutting plane or departs from a parallel alignment.

The invention will be described in the following by way of example with reference to the drawing. There are shown:

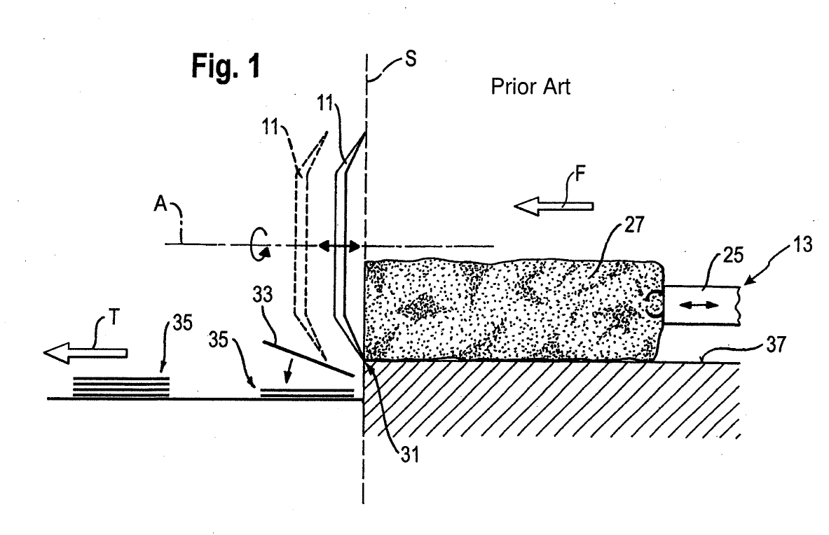

FIG. 1 a schematic representation of the functional principles of a slicer having an axially adjustable cutting blade in accordance with the prior art;

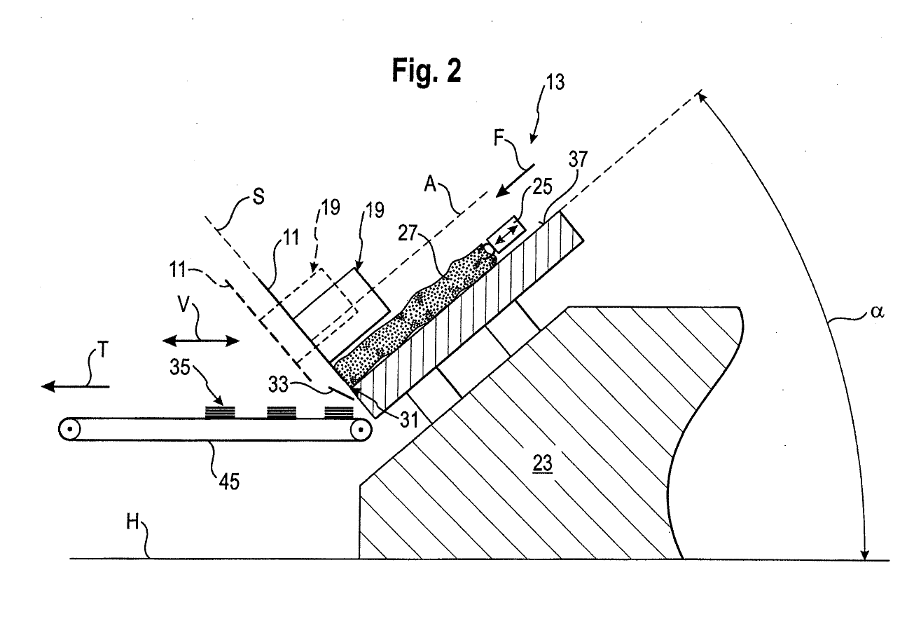

FIG. 2 a schematic side view of a slicer in accordance with the invention with a horizontally adjustable blade head;

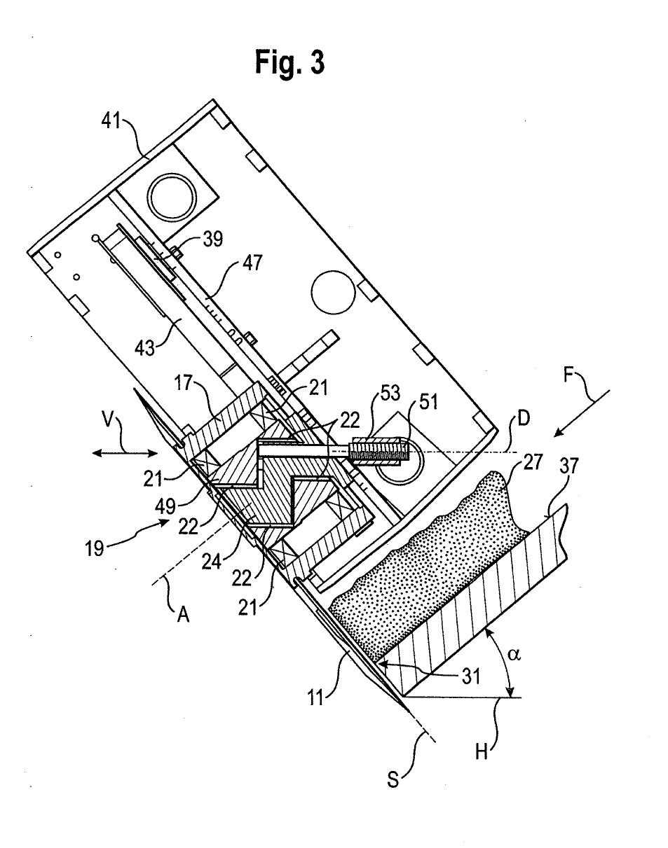

FIG. 3 schematically, a side view of a possible specific embodiment of a cutting head of a slicer in accordance with the invention;

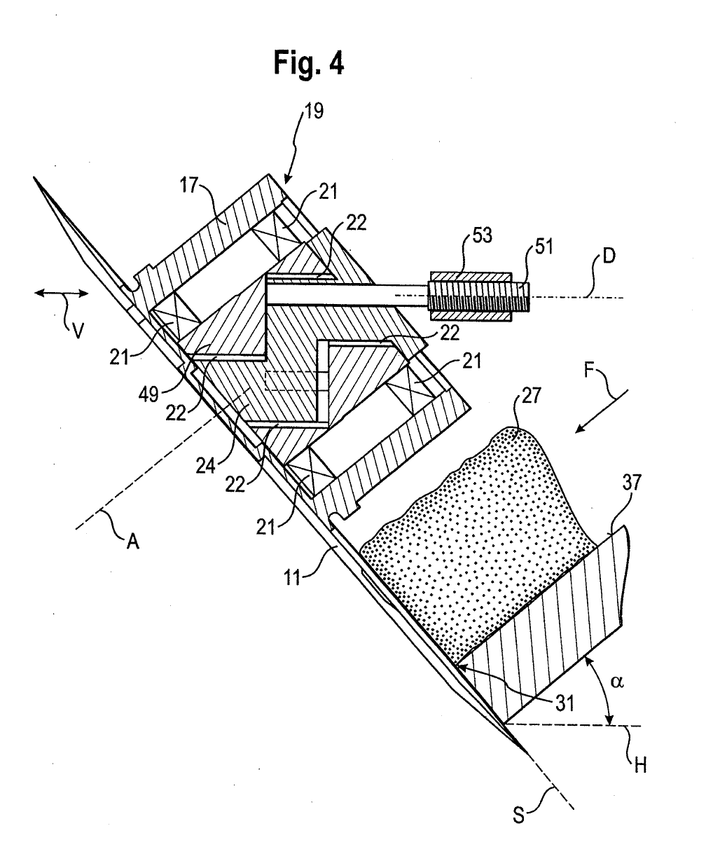

FIG. 4 a section of FIG. 3 shown enlarged with a blade in the cutting position,

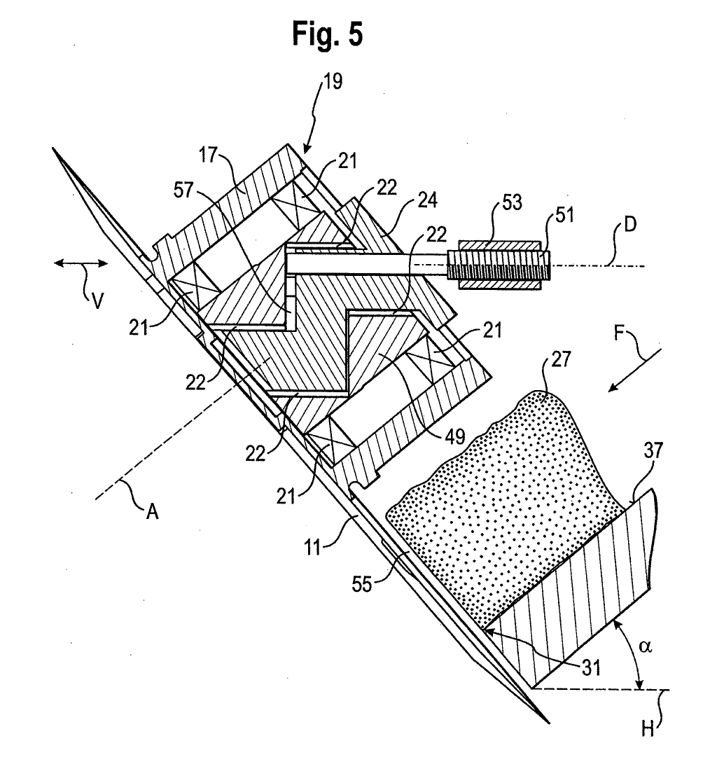

FIG. 5 a representation in accordance with FIG. 4 with a cutting blade in a disengaged position,

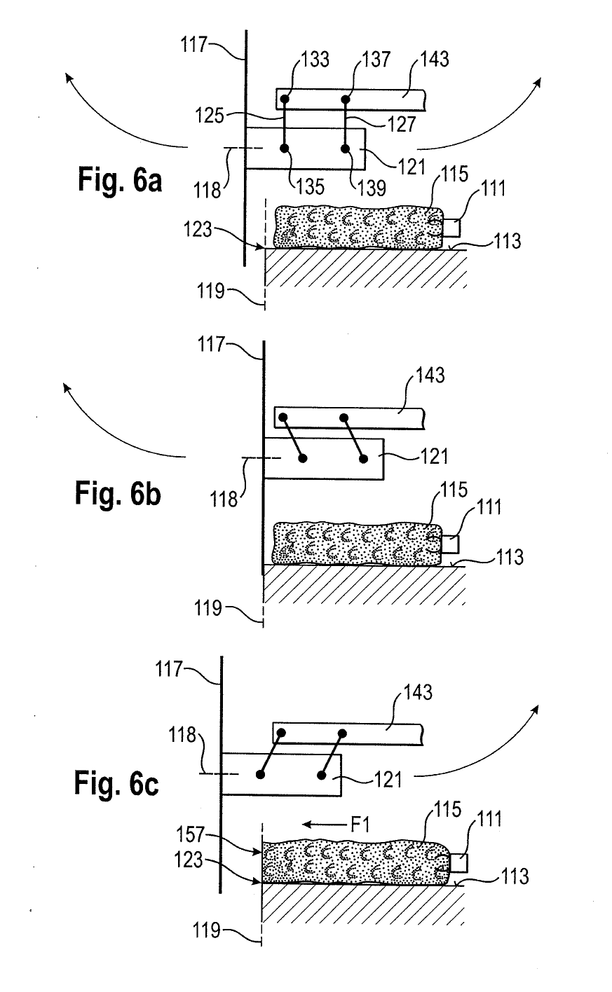

FIGS. 6a-6c schematically, a slicing apparatus in accordance with the invention with a cutting blade in different pivoted positions;

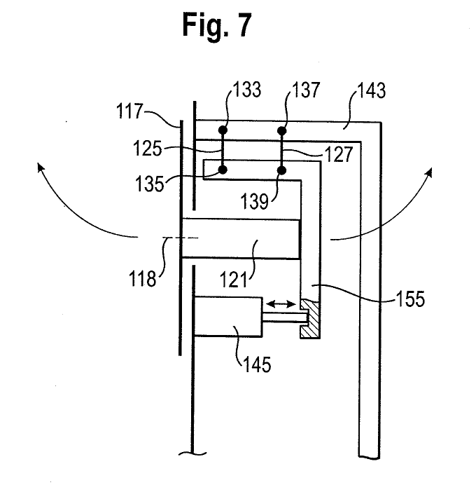

FIG. 7 schematically, a slicing apparatus in accordance with the invention in accordance with a further embodiment; and

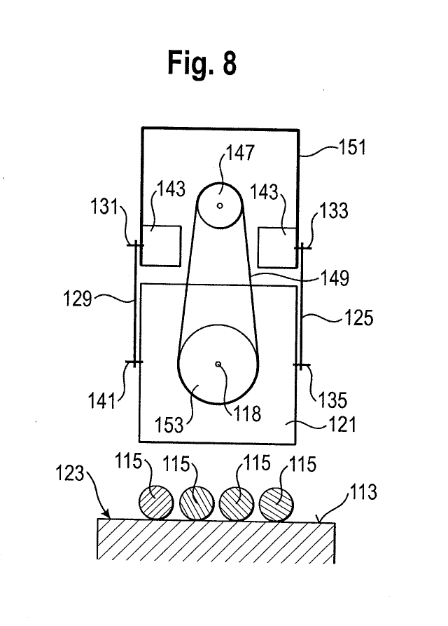

FIG. 8 schematically, a slicing apparatus in accordance with the invention in accordance with a further embodiment.

In the following different reference numerals will also be used for such parts and terms which actually correspond to one another.

The embodiments explained in the following can either be combined with one another or can each be separately realized.

FIG. 1 shows in a schematic side view a high-performance slicer known from the prior art which serves to cut food products 27 such as meat, sausage, ham or cheese into slices. During the cutting procedure, the product 27 lies on a product support 37 and is moved along a product feed direction F in the direction of a cutting plane S by means of a product feed 13. The product feed direction F extends perpendicular to the cutting plane S. As mentioned in the introduction part, such slicers are also known in which the angle between the product feed direction and the cutting plane is different from 90° Only the already mentioned product support 37 as well as a so-called product holder 25 are shown of the product feed 13 in FIG. 1, said product holder engaging with claws or grippers into the rear end of the product 27 and being drivable by drive means, not shown, in and against the product feed direction F, as is indicated by the double arrow.

The cutting plane S is defined by the edge of a cutting blade 11 which cooperates during the slicing operation with a cutting edge 31 which is also called a counter-blade and which forms the front end of the product support 37. In practice, the cutting edge is usually a separate, replaceable component, e.g. made from plastic or steel, which is not shown here for reasons of simplicity.

As mentioned in the introduction part, the cutting blade 11 can be a so-called circular blade which both orbits a center axis in a planetary manner and rotates about a separate blade axis. Alternatively, the cutting blade 11 can be a so-called scythe-like blade or spiral blade which does not orbit in a planetary manner, but rather only rotates about the blade axis A. The drive for the cutting blade 11 is not shown in FIG. 1.

In order to establish a spacing between the blade 11 and the front end of the product 27 within the framework of an additional function of the slicer, an adjustment device, not shown, is provided which is made to move the cutting blade 11. As indicated by the double arrow in FIG. 1, it is known from the prior art to move the cutting blade parallel to its axis of rotation (blade axis) A. For this purpose, the cutting blade 11 can be displaceably journalled parallel to the axis of rotation A. In connection with the carrying out of blank cuts, with a disengaged blade 11 (indicated by a broken line in FIG. 1), that is with a blade 11 spaced apart from the front product end, scrap formation or snippet formation is reliably avoided.

With a portion-wise slicing of the product 27, as is shown in FIG. 1, the cut-off product slices 33 form portions 35 which are shown as slice stacks in FIG. 1. As soon as a portion 35 is completed, this portion 35 is transported away in a direction T. So that sufficient time is available for the transporting away of the finished slice portions 35, the mentioned blank cuts are carried out until the start of the formation of the next portion 35, for which purpose the product feed, also called a product advance, (that is here the product holder 25) is stopped, on the one hand, and the cutting blade 11 is moved, on the other hand, by means of the mentioned adjustment device into the position shown by broken lines in FIG. 1.

FIG. 2 schematically shows a slicer in accordance with the invention in a side view. The product feed 13 is shown in that position in which the product 27 is being sliced. The product feed 13 can be pivoted into an at least approximately horizontal position for loading with a new product. In the cutting position shown, however, the product feed 13 and thus the product feed direction F is inclined with respect to the horizontal, and indeed by an angle a which amounts, for example, approximately to 40°.

Since in this embodiment the product feed direction F and thus the plane defined by the product support 37 extends parallel to the blade axis A (which is, however, not absolutely necessary—as already mentioned above), the angle of inclination a is here drawn between the horizontal H and the plane of the product support 37.

During the slicing, the product support 37 thus represents a slanted plane for the product 27. The advance direction of the product 27 is hereby assisted by the earth's gravitational pull. It is, however, of greater importance that due to the oblique position of the product feed 13, the front product end is not oriented vertically—as would be the case with a horizontally lying product—so that due to the inclination of the front product end, the depositing of the cut-off product slices 33—on a belt 45 for transporting away here—is improved or a usable product depositing is only made possible at all.

The slicing of food products 27 with a product feed 13 inclined with respect to the horizontal H is sufficiently known from the prior art. Practically all high-performance slicers work with such an oblique product feed 13.

Whereas the cutting blade 11 is moved—in accordance with the representation in FIG. 1—parallel to the blade axis A in slicers known from the prior art in order, for example, to achieve a spacing between the cutting blade 11 and the front product end for carrying out blank cuts, a horizontal adjustment movement of the cutting blade 11 is provided in accordance with the invention in the embodiment of FIG. 1 shown as is indicated by the horizontally extending double arrow indicating the adjustment direction V.

Whereas the cutting position of the blade 11 in which the cutting plane S and a reference plane defined by the cutting edge 31 coincide is shown with solid lines, the disengaged position of the blade 11 is indicated by broken lines in FIG. 2. In this respect, the blade 11 or a blade holder is not adjusted alone, but rather the blade head 19 only indicated schematically here as a whole. This will be looked at in more detail in the following in connection with FIGS. 3 to 5. The adjustment movement of the blade 11 or of the blade head 19 ultimately takes place relative to a fixed-position frame or rack 23 of the slicer. This will also be looked at in more detail in the following in connection with FIGS. 3 to 5.

Whereas the structure and the adjustment of the blade head 19 will be explained in more detail with reference to FIGS. 4 and 5, FIG. 3 provides an overview of this possible specific embodiment of the invention. The blade head 19 is a scythe-like blade head, i.e. the cutting blade 11 is a scythe-like blade which carries out a separate rotational movement about the blade axis A and does not additionally orbit it in a planetary manner.

The blade 11 is replaceably attached to what is here called a blade holder 17 which is also called a blade mount, rotor or blade shaft. The possible designation as a blade shaft is also selected because in the embodiment shown here the blade holder 17 is that component of the blade head 19 which is set into rotation directly—namely by a drive belt 43—by the rotary drive 39 of the slicer.

The blade head 19 movable to and fro as a whole in the adjustment direction V furthermore includes a base part 49 which does not rotate. Roller element bearings 21 are arranged between the blade holder 17 and the base part 49.

The base part 49 and thus the blade head 19 is therefore displaceable via plain bearings or slide bearings 22 in the adjustment direction V, that is horizontally, and thus obliquely to the blade axis A and to the product feed direction F relative to a carrier 24.

The carrier 24 having approximately an S shape or Z shape is fixedly connected to a wall 47 which is a component of a cutting head housing 41 which is attached to a rack or frame 23 stationary with respect to the adjustment direction V (cf. FIG. 2). An adjustability of the cutting head housing 41 as a whole in directions which lie in the cutting plane S are furthermore possible relative to the product support 37, but are otherwise of no further meaning for the subject matter of the invention.

A cover or hood which is connected to the cutting head housing 41 and which at least partly surrounds the cutting blade during the cutting operation is likewise provided, but is not shown in FIGS. 3 to 5.

An adjustment device for the blade head 19 which includes a spindle drive having a spindle 51 and a spindle nut 53 is supported at the cutting head housing 41, with alternatively a support of the spindle drive (or generally of an adjustment drive for the cutting blade 11 or for the blade head 19 of any design) also being able to be provided at the carrier 24.

A drive motor, not shown, is made to rotate the spindle nut 53 fixedly connected to the cutting head housing 41 in the adjustment direction V on demand about an axis of rotation D of the spindle drive. Depending on the direction of rotation of the spindle nut 53, the spindle 51 consequently moves to the left or to the right in FIG. 3. The front end of the spindle 51 at the left in FIG. 3 is fixedly connected to the base part 49 and thus to the blade head 19 with respect to the adjustment direction V. The activation of the spindle drive thus provides—in dependence on the direction of rotation of the spindle nut 53—a movement of the cutting blade 1111 away from the front end of the product 27 or away from the cutting edge 31 or toward the front product end or toward the cutting edge 31.

Whereas FIG. 4 shows the cutting position in which the cutting plane S defined by the blade 11 coincides with a reference plane defined by the cutting edge 31, the blade 11 is in a disengaged position in FIG. 5.

Since the adjustment movement of the blade head 19 and thus of the blade 11 takes place in the horizontal direction and thus obliquely to the product feed direction F, the spacing 55 measured in the product feed direction F (FIG. 5) between the front product end and the plane defined by the blade edge is smaller than the path covered in the adjustment direction V by the blade head 19, i.e. smaller than the gap 57 caused by the adjustment movement between the carrier 24 fixedly connected to the cutting head housing 41 (cf. FIG. 3) and the base part 49.

Whereas in the embodiment of FIGS. 3 to 5, the blade head 19 is adjusted as a whole, it is generally alternatively also possible only to move the blade holder 17 in the horizontal adjustment direction V, and indeed relative to the remaining components of the blade head 19, in particular relative to the rotary bearing required for the rotating blade holder 17. With an angle—as given here—different from zero between the adjustment direction V of the rotating blade holder 17 and the axis of rotation A of the rotary bearing, a movement of only the blade holder relative to its own rotary bearing does not represent a trivial construction task; it is nevertheless solvable for the skilled person if faced with this object.

In a further alternative of the embodiment shown, instead of the shown scythe-like blade head 19, a circular blade head can also be provided and can be adjusted in the horizontal direction V. These different blade heads, on the one hand, and the carrier 24 relative to which the adjustment movement takes place in the adjustment direction V, on the other hand, can in particular be designed in the form of a universal, mutually matched interface or coupling device so that a single cutting head housing 41 with an adjustment device, e.g., with a spindle drive 51, 53, can be coupled both to a scythe-like blade head and to a circular blade head. On a matching of the different blade heads also with respect to the required rotary drive, the same rotary drive can then also be used for the different blade heads.

With respect to the drive belt 43 shown in FIG. 3 for the rotary drive of the blade holder 17 about the blade axis A, it must still be mentioned that in accordance with the invention additional measures can be provided which have not previously been mentioned in order at least partly to compensate the deflection or the stretching of the drive belt 43 which occurs on the adjustment of the blade head 19 and thus of the blade holder 17 in the direction of rotation V directly rotationally driven by the drive belt 43. A measure for this purpose can comprise also moving the rotary drive motor of the rotary drive 39 in a manner matched to the adjustment movement of the blade head 19 on the adjustment of the blade head 19 such that the effects of the blade head adjustment movement on the drive belt 43 are at least compensated up to a specific degree.

The effect of the belt stretching or belt deflection can also be at least largely eliminated by a suitable orientation of the blade head. For this purpose, the blade head can be installed such that its longitudinal axis does not coincide with the rotary axis, but is rather mounted tilted by a specific angle with respect to it. It can result in this respect that the adjustment direction does not extend exactly horizontally, but rather obliquely to the horizontal.

In the embodiment of FIGS. 6a to 6c, a cutting head 121 including a cutting blade 117 is pivotably journalled as a whole at a base 143 of the slicer not completely shown here.

The cutting blade 117 is a scythe-like blade or a spiral blade which can be driven by a rotary drive, not shown, to rotate about an axis of rotation 118. Alternatively, the pivotable journalling can also be provided for a circular blade head whose blade rotates and additionally orbits in a planetary manner.

For the pivotable journalling of the cutting blade 121, a parallelogram guiding part is provided which in this embodiment includes two guiding part pairs. Only one respective guiding part 125 and 127 respectively is shown of the front and rear guiding part pairs in the direction F1 of the product feed (cf. FIG. 6c).

The pivot axes 133 to 139 of the guiding parts 125, 127 at the base 143 and at the cutting head 121 are disposed in parallel planes respectively extending perpendicular to a reference plane 119. The guiding parts 125, 127 moreover have the same lengths. The orientation or position of the cutting blade 117 in space consequently does not change on a pivoting, as the comparison of FIGS. 6a to 6c with one another shows. The cutting blade 117 remains aligned parallel to the reference plane 119 in every pivoted position.

Alternatively, the guiding parts or the guiding part pairs 125, 127 can be of different lengths and/or the pivot axes 133 to 139 or pivotal connection points can be disposed in planes not extending parallel to the reference plane 119. Depending on the specific embodiment, an alignment of the cutting blade 117 always parallel to the reference plane 119 can either nevertheless be realized or a movement of the cutting blade 117 differing therefrom can be realized on the pivoting e.g. with the aim of deliberately pivoting the cutting blade 117 out of a parallel position. The length of the guiding parts or guiding part pairs 125, 127 and/or the pivot axes 133 to 139 can also be made adjustable to be able directly to preset different movements of the cutting blade 117 on the pivoting in this manner.

A pivot drive effecting the pivot movement of the cutting head 121 is not shown in FIGS. 6a to 6c.

The mentioned reference plane 119 is defined with respect to its axial position, that is its position with respect to the product feed direction F1, by the cutting edge 123 forming the end of a product support 113. In addition, the reference plane 119 extends perpendicular to the product feed direction. The axis of rotation 118 of the cutting blade 117 extends perpendicular to the product feed direction and thus parallel to the product feed direction F1.

Due to the parallelogram guiding part, which can also be called a parallelogram guide or a four-bar lever, the axis of rotation 118 remains aligned parallel to the product feed direction F1 in every pivoted position of the cutting blade 117.

Due to the pivotable journalling in accordance with the invention of the cutting blade 117 or of the cutting head 121 including the cutting blade 117, an axially movable journalling of the cutting blade 117 is not necessary, i.e. it is not necessary to displace the cutting blade 117. Special slide bearing means or plain bearing means such as a plain bearing sleeve are consequently not necessary in conjunction with the invention. In accordance with the invention, the desired change in the spacing between the cutting blade 117 and the reference plane 119 takes place only by a pivoting or by one or more rotational movements.

The movement which the cutting head 121 carries out on the pivoting is a superimposition of two pivot movements or individual pivot movements: On the pivoting of the cutting head 121, it is pivoted, on the one hand, relative to the base 143 about the pivot axis 133 by means of the front guiding part pair 125. On the other hand, the cutting head 121 is pivoted about the other pivot axis 135 of the front guiding part pair 125. The rear guiding part pair 127 provides this in the sense of a positive guidance. Depending on the pivot movement about the pivot axis 133, the pivoting of the cutting head 121 about the pivot axis 135 is guided by the rear guiding part pair 127 such that the position of the axis of rotation 118 and of the cutting blade 117 in space does not change. The cutting blade 117 consequently always remains parallel to the reference plane 119 and thus to the cutting plane during the pivoting.

This action of the parallelogram guiding part in accordance with the invention can be described in an analog manner starting from the rear guiding part pair 127: the cutting head 121 is pivoted as a whole about the pivot axis 137 relative to the base 143 and simultaneously in a manner guided by the front guiding part pair 125 about the other pivot axis 139 of the rear guiding part pair 127.

In the embodiment of FIGS. 6a to 6c, the cutting head 121 is pivotably suspended at the base 143. FIG. 6a, in which the guiding parts 125, 127 extend parallel to the reference plane 119, shows the “lowest” position of the cutting head 121. On the pivoting in the one or in the other direction, the cutting head 121 consequently moves along the respective branch of a U-shaped track, whereby the cutting head 121 and thus the cutting blade 117 is additionally slightly raised, i.e. is moved parallel to the reference plane 119.

This pivot-induced blade stroke is, however, completely unproblematic in practice and in particular for the cutting quality since it must be taken into account in this connection—as already mentioned above—that the axial displacement path of the cutting blade 117, that is the axial displacement path measured of the cutting blade in the product feed direction F1, which is effected by the pivoting of the cutting head 117, only lies in the order of magnitude of millimeters.

As already mentioned in the introduction part, the pivoting of the cutting head 121 and of the axial offset of the cutting blade 117 resulting therefrom can serve different purposes, and indeed in particular for carrying out blank cuts and for setting the cutting gap.

The illustrations in FIGS. 6a to 6c were selected only for the purpose of an illustrative explanation such that FIGS. 6a and 6b show two possible cutting gap settings purely by way of example. In FIG. 6a, the gap between the cutting edge 123 and the cutting blade 117 is relatively large (and is here actually shown disproportionately large), whereas in FIG. 6b, the plane defined by the blade edge of the cutting blade 117 and the plane 119 defined by the cutting edge 123 coincide and thus a cutting gap of zero is set. In practice, cutting can take place both with a cutting gap set to zero in accordance with FIG. 6b, in particular in conjunction with a dynamic cutting gap setting, and a cutting gap different from zero can be present between the cutting edge 123 and the cutting blade 117 during the cutting.

It can be seen from FIG. 6a that—as already explained above—the definition of a cutting plane is only exactly possible when the cutting plane is either considered as defined by the edge of the blade 117 or as defined by the cutting edge 123 as long as the respective planes do not coincide.

FIG. 6c illustrates a situation during the slicing of a product 115 in which blank cuts are just being carried out. The product advance 111 which engages at the rear product end and which can be driven in the product feed direction F1 during the slicing to feed the product 115 to the cutting blade 117 is set out of operation in this situation. In addition, the cutting head 121 is pivoted so far by means of a pivot drive, not shown, that a sufficiently large spacing is present between the front product end 157 adjoining the cutting edge 123, on the one hand, and the cutting blade 117, on the other hand, in order, in this situation reliably to prevent the cutting of scraps from the product 115 by the cutting blade 117 also still rotating about the axis 118 in this situation.

As soon as the slice portion (not shown) previously formed by cutting slices from the product 115 is transported away, the cutting head 121 is again pivoted back to restart the cutting of slices from the product 115 so that the cutting blade 117 again adopts its original cutting position which corresponds, for example, to the position in accordance with FIG. 6a, the position in accordance with FIG. 6b or a position disposed therebetween.

In the embodiment shown schematically in FIG. 7, the parallelogram guiding parts 125, 127 do not directly engage at the cutting head 121, but rather at a carrier 155 which is connected to the cutting head 121.

The cutting head 121 is located between an upper section of the carrier 155, which is connected via a parallelogram guiding part to a base 143 of the slicer, and a lower section at which a pivot drive 145 engages which is likewise supported at the base 143. The pivot drive 145 is, for example, a piston-in-cylinder arrangement which—as indicated by the double arrow in FIG. 7—is able to act on the carrier 155 along a line of action which extends parallel to the axis of rotation 118 of the cutting blade 117 and thus perpendicular to the cutting plane.

In this respect, the pivot drive 145 is coupled with the carrier 155 such that, on the one hand, a movement of the carrier 155 in both directions is possible, that is the carrier 155 together with the cutting head 121 can both be “pushed” and “pulled” and, on the other hand, the stroke perpendicular to the axis of rotation 118 also taking place by the pivoting of the carrier 155 can be started (for example by an elongated hole guide) without a corresponding stroke movement of the pivot drive 145 being necessary for this purpose. Alternatively, the pivot drive 145 can be movable journalled to be able to follow the movement of the cutting head 121 and thus to avoid a clearance between the pivot drive 145 and the cutting head 121.

FIG. 8 shows a schematic view of a further slicing apparatus in accordance with the invention along the axis of rotation 118 of the cutting blade not shown here. The cutting head 121 includes a blade holder 153 to which the cutting blade can be replaceably fastened. A rotary drive 147 not belonging to the cutting head 121 in this embodiment is able to set the blade holder 153 into rotation about the axis 118 by means of a drive belt 149.

The cutting head 121, but in this embodiment not the rotary drive 147, is pivotably suspended at a base 143, and indeed in turn via a parallelogram guiding part of which only one guiding part pair 125, 129 is shown here whose guiding parts are pivotally connected to the base 143 about pivot axes 131, 133 and to the cutting head 121 about pivot axes 135, 141.

Both the pivot movement of the cutting head 121 and the stroke of the cutting head 121 perpendicular to the axis of rotation 118 adopted in this process can be started without problem by the drive belt 149 without impairing the rotary drive of the blade holder 153.

It is generally also possible in accordance with the invention in deviation from the concept of FIG. 8 to integrate the rotary drive 147 into a cutting head pivotable as a whole.

As is indicated in FIG. 8 by the four products 115 lying next to one another on the product support 113, a plurality of products 115 can also be sliced simultaneously using the slicer in accordance with the invention, and indeed using only one single cutting blade.

### REFERENCE NUMERAL LIST

11 cutting blade
13 product feed
15 adjustment device
17 blade holder
21 blade head
22 rotary bearing
22 plain bearing or slide bearing
23 rack
24 carrier fixed to rack
25 product holder
27 product
31 cutting edge
33 product slice
25 slice portion
37 product support
39 rotary drive
41 cutting head housing
43 drive belt
45 belt for transporting away
47 wall
49 base part
51 spindle
53 spindle nut
55 spacing
57 gap
A blade axis
F product feed direction
S cutting plane
T transporting-away direction
V adjustment direction
H horizontal axis
D axis of rotation of the spindle drive
α angle of inclination
111 product advance
113 product support
115 product
117 cutting blade
118 axis of rotation of the blade
119 reference plane
121 cutting head
123 cutting edge
125 guiding part
127 guiding part
129 guiding part
131 pivot axis
133 pivot axis
135 pivot axis
137 pivot axis
139 pivot axis
141 pivot axis
143 base
145 pivot drive
147 rotary drive
149 drive belt
151 housing
153 knife holder
155 carrier
157 front product end
F1 product feed direction

1. An apparatus for slicing food products (27; 115), in particular a high-performance slicer, comprising
a product feed (13; 111, 113;
at least one cutting blade (11; 117) which rotates about a blade axis (A) and/or orbits a center axis in a planetary manner and to which at least one product (27; 115) to be sliced can be fed in a produce feed direction (F); and
an adjustment device (15) for the cutting blade (11; 117) with which the cutting blade (11; 117) is movable in an adjustment direction (V),
wherein the blade axis (A) and/or the center axis of the cutting blade (11; 117) is inclined with respect to the horizontal (H) during the slicing; and
wherein the adjustment direction (V) of the cutting blade (11; 117) extends obliquely to the blade axis (A) and/or the center axis of the cutting blade (11; 117).

2. An apparatus in accordance with claim 1,
characterized in that
the adjustment direction (V) of the cutting blade (11; 117) extends at least approximately horizontally.

3. An apparatus in accordance with claim 1,
characterized in that
the blade axis (A) and/or the center axis of the cutting blade (11; 117) extends at least approximately parallel to the product feed direction (F).

4. An apparatus in accordance with claim 1,
characterized in that
the adjustment movement of the cutting blade (11; 117) is a linear movement.

5. An apparatus in accordance with claim 1,
characterized in that
the adjustment device (16) for the cutting blade (11; 117) includes a linear drive, in particular a spindle drive or a cylinder-in-piston arrangement.

6. An apparatus in accordance with claim 5,
characterized in that
an axis of rotation (D) of a spindle drive or a longitudinal axis of a cylinder-in-head arrangement extends parallel to the adjustment direction (V) of the cutting blade (11; 117).

7. An apparatus in accordance with claim 1,
characterized in that
the adjustment device for the cutting blade includes an eccentric drive.

8. An apparatus in accordance with claim 1,
characterized in that
the angle of inclination (a) between the blade axis (A) and/or the center axis of the cutting blade (11; 117) and the horizontal (H) lies in the range from 30° to 50°, and in particular amounts to at least approximately 40°, during the slicing.

9. An apparatus in accordance with claim 1,
characterized in that
a blade holder (17) to which the cutting blade (11) is replaceably attachable is movable in the adjustment direction (V).

10. An apparatus in accordance with claim 1,
characterized in that
a blade holder to which the cutting blade is replaceably attachable is movable in the adjustment direction relative to at least one rotary bearing for the movement of the cutting blade about the blade axis and about the central axis and relative to a base part via which the blade holder is attachable to a carrier fixed to the rack.

11. An apparatus in accordance with claim 1,
characterized in that
a blade head (19) is movable as a whole in the adjustment direction (V), with the blade head (19; 121) preferably including a blade holder (17) to which the cutting blade (11; 117) is replaceably attachable and at least one rotary bearing (21) for the movement of the cutting blade (11; 117) about the blade axis (A) and/or about the center axis.

12. An apparatus in accordance with claim 11,
characterized in that
the blade head (19; 121) is made as a scythe-like blade head for a scythe-like blade (11; 117) rotating about the blade axis (A).

13. An apparatus in accordance with claim 11,
characterized in that
the blade head is made as a circular blade head for a circular blade rotating about the blade axis and orbiting the center axis in a planetary manner.

14. An apparatus in accordance with claim 1,
characterized in that
a fixed-position rack (23) is provided, with a blade head (19; 121) as a whole or a blade holder to which the cutting blade is replaceably attachable being movable relative to a carrier (24) fixed to the rack in the adjustment direction (V).

15. An apparatus in accordance with claim 1,
characterized in that
a plain bearing or slide bearing (22) is provided between the blade head (19; 121) and the carrier (24) or between a blade holder to which the cutting blade is replaceably attachable and at least one rotary bearing for the movement of the cutting blade about the blade axis and/or about the center axis.

16. An apparatus in accordance with claim 14,
characterized in that
the carrier (24) is arranged at or in a cutting head housing (41).

17. An apparatus in accordance with claim 15,
characterized in that
the carrier (24) is arranged at or in a cutting head housing (41).

18. An apparatus in accordance with claim 14,
characterized in that
the carrier (24) for the blade head (19; 121) is made universal such that a change can be made between a scythe-like blade head and a circular blade head.

19. An apparatus in accordance with claim 15,
characterized in that
the carrier (24) for the blade head (19; 121) is made universal such that a change can be made between a scythe-like blade head and a circular blade head.

20. An apparatus in accordance with claim 1,
characterized in that
a rotary drive (39) is associated with a blade head (19; 121).

21. An apparatus in accordance with claim 20,
characterized in that
the rotary drive (39) is arranged fixed to the rack or is able to make a compensation movement coordinated with the adjustment movement of the cutting blade (11; 117).

22. An apparatus in accordance with claim 20,
characterized in that
the rotary drive (39) is arranged together with the blade head (19; 121) at or in a cutting head housing (41) fixed to the rack.

23. An apparatus in accordance with claim 20,
characterized in that
the rotary drive (39) cooperates with the blade head (19; 121) carrying out the adjustment movement as a whole or with a part of the blade head carrying out the adjustment movement, in particular with a blade holder, in particular via at least one drive belt (43).

24. An apparatus in accordance with claim 1,
characterized in that
the cutting blade (11; 117) is movable in the adjustment direction (V) such that the spacing between the cutting blade (11; 117) and a reference plane which extends parallel to a cutting plane (S) defined by the edge of the cutting blade (11; 117) is changed.

25. An apparatus in accordance with claim 1,
characterized in that
the cutting blade (11; 117)) is movable in the adjustment direction (V) for carrying out at least one additional function, in particular for carrying out blank cuts and/or for the cutting gap setting.

26. Use of an apparatus for slicing food products (27; 115), in particular a high-performance slicer, comprising
a product feed (13; 111, 113;
at least one cutting blade (11; 117) which rotates about a blade axis (A) and/or orbits a center axis in a planetary manner and to which at least one product (27; 115) to be sliced can be fed in a produce feed direction (F); and
an adjustment device (15) for the cutting blade (11; 117) with which the cutting blade (11; 117) is movable in an adjustment direction (V),
wherein the blade axis (A) and/or the center axis of the cutting blade (11; 117) is inclined with respect to the horizontal (H) during the slicing; and
wherein the adjustment direction (V) of the cutting blade (11; 117) extends obliquely to the blade axis (A) and/or the center axis of the cutting blade (11; 117) and wherein, for carrying out blank cuts, in particular on the portion-wise slicing of food products, the cutting blade (11; 117) is moved away from the front product end and is moved back again to restart the cutting of slices from the product (27; 115) after carrying out one or more blank cuts for the temporary interruption of the cutting of slices from the product (27; 115).

27. Use of an apparatus for slicing food products (27; 115), in particular a high-performance slicer, comprising
a product feed (13; 111, 113;
at least one cutting blade (11; 117) which rotates about a blade axis (A) and/or orbits a center axis in a planetary manner and to which at least one product (27; 115) to be sliced can be fed in a produce feed direction (F); and
an adjustment device (15) for the cutting blade (11; 117) with which the cutting blade (11; 117) is movable in an adjustment direction (V),
wherein the blade axis (A) and/or the center axis of the cutting blade (11; 117) is inclined with respect to the horizontal (H) during the slicing;
wherein the adjustment direction (V) of the cutting blade (11; 117) extends obliquely to the blade axis (A) and/or the center axis of the cutting blade (11; 117) and
wherein, for setting a cutting gap, the gap between the cutting blade (11; 117) and a cutting edge (31; 123) is set to a preset dimension by moving the cutting blade (11; 117).

28. A method of slicing food products, wherein
at least one product (27; 115) is fed by means of a product feed (13; 111, 113) to a cutting plane in which at least one cutting blade (11; 117) is moved, in particular in a rotating and/or orbiting manner, for cutting slices from the product (27; 115), the at least one cutting blade rotating about a blade axis (A) and/or orbiting a center axis in a planetary manner; wherein the blade axis (A) and/or the center axis of the cutting blade (11; 117) is inclined with respect to the horizontal (H) during the slicing; and
the cutting blade (11; 117)) is moved for carrying out at least one additional function, in particular for carrying out blank cuts, for setting the cutting gap and/or for the vertical and/or dipping depth setting in an adjustment direction (V) extending obliquely to the blade axis (A) and/or to the center axis of the cutting blade (11; 117).
